(19) United States
(12) Patent Application Publication
(10) Pub. No.: US 2015/0371305 A1
(43) Pub. Date: Dec. 24, 2015

(54) AUTOMATED SYSTEM AND METHOD FOR FACILITATING MOVING LOGISTICS

(71) Applicant: Venkatesh GANAPATHY, Columbus, OH (US)

(72) Inventor: Venkatesh GANAPATHY, Columbus, OH (US)

(21) Appl. No.: 14/747,678

(22) Filed: Jun. 23, 2015

Related U.S. Application Data
(60) Provisional application No. 62/016,430, filed on Jun. 24, 2014.

(51) Int. Cl. G06Q 30/06; G06F 17/30

(52) U.S. Cl. CPC G06Q 30/0613; G06F 17/30339; G06F 17/30345; G06F 17/3053; G06F 17/30554

(57) ABSTRACT

An automated system for facilitating moving and relocation logistics that includes a plurality of service providers and vendors, wherein the service providers and vendors are associated with moving or relocation activities; automated means for compiling information about each of the service providers and vendors and ranking them in accordance with various predetermined criteria; at least one computerized database for containing information about the service providers and vendors and for storing the ranking data; and at least one computerized device in communication with the at least one database, wherein the at least one computerized device further includes software for managing customer data input, account information, and executing commands related to engaging one or more of the service providers or vendors based on the ranking data.

### CROSS-REFERENCE TO RELATED APPLICATIONS

This patent application claims the benefit of U.S. Provisional Patent Application Ser. No. 62/016,430 filed on Jun. 24, 2014 and entitled “Automated System and Method for Facilitating Moving Logistics”, the disclosure of which is hereby incorporated by reference herein in its entirety and made part of the present U.S. utility patent application for all purposes.

### BACKGROUND OF THE INVENTION

The described invention relates in general to a system and method for planning and executing the process of moving or relocating, and more specifically to a computer automated or application software-based system for facilitating and/or effectively managing the full spectrum of moving logistics.

The present invention provides a comprehensive online moving concierge platform that helps consumers organize different aspects of their move with the help of a web and/or a mobile app (application software) by providing automated timely reminders for different tasks during their move and aggregating and integrating several services within the same platform to help consumers complete those tasks in a relatively hassle free and partially or fully automated manner.

People often move for positive reasons, e.g., a new job, a new house, a better neighborhood or a shorter commute; however, moving is often considered to be the third most stressful event in a person's life. The stress begins with people having to take care of hundreds of things, including, but not limited to, finding a good mover, changing utilities, finding baby sitters or pet care professionals, plumbers, painters, trying to sell their old furniture or appliances, finding new furniture and much more. Since there is no comprehensive website for searching all of these services, consumers have to research multiple sites to look for good vendors. Most online resources available today, however, are conventional lead providers whose business model is based on collecting and selling consumer contact information. As a result, instead of providing the information consumers were looking for, these sites pass on their information to a group of affiliated vendors. Unfortunately, consumers do not have any control in selecting the vendors to whom their information is being sent and as a result they end up losing their privacy, thereby leading to incessant phone calls and emails. To compound the problem, the consumer will still have to do their own research on vendor reviews and ratings from different websites before making their decision. And they have to do all of this within a short amount of time while working or transitioning from their work and managing their family life.

As a result of reduced time and the stress of the impending move, consumers often end up choosing a bad service provider resulting in them falling prey to bait-and-switch pricing scams, loss or damage of property, and unplanned expenses. Despite all of this, they still tend to forget a number of small things such as changing their mailing address on time, updating their DMV and bank records or even setting up utilities on time, thereby resulting in much of inconvenience. This combination of lost time, lost money, and lost privacy makes moving one of the most stressful events in life. What is most surprising is that despite over 32MM people (around 16MM households) moving every year and spending a total of over $16B annually, there is a lack of a comprehensive online resource that helps consumers with their moving process (American Movers & Storage Association, Industry Fact Sheet 2010; US Census Mobility Report, 2010; IBIS Truck Rental Report). Thus, there is an ongoing need for a computer automated or application software-based system for facilitating and executing the full spectrum of moving logistics.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, an automated system for facilitating moving and relocation logistics is provided. This system includes a plurality of service providers and vendors, wherein the service providers and vendors are associated with moving or relocation activities; automated means for compiling information about each of the service providers and vendors and ranking them in accordance with various predetermined criteria; at least one computerized database for containing information about the service providers and vendors and for storing the ranking data; and at least one computerized device in communication with the at least one database, wherein the at least one computerized device further includes software for managing customer data input, account information, and executing commands related to engaging one or more of the service providers or vendors based on the ranking data.

In accordance with another aspect of the present invention, a first automated method for facilitating moving and relocation logistics is provided. This method includes providing a plurality of service providers and vendors, wherein the service providers and vendors are associated with moving or relocation activities; providing automated means for compiling information about each of the service providers and vendors and ranking them in accordance with various predetermined criteria; providing at least one computerized database for containing information about the service providers and vendors and for storing the ranking data; and providing at least one computerized device in communication with the at least one database, wherein the at least one computerized device further includes software for managing customer data input, account information, and executing commands related to engaging one or more of the service providers or vendors based on the ranking data.

In yet another aspect of this invention, a second automated method for facilitating moving and relocation logistics is provided. This method includes providing a plurality of service providers and vendors, wherein the service providers and vendors are associated with moving or relocation activities; providing automated means for compiling information about each of the service providers and vendors and ranking them in accordance with various predetermined criteria; providing at least one computerized database for containing information about the service providers and vendors and for storing the ranking data; providing at least one computerized device in communication with the at least one database, wherein the at least one computerized device further includes software for managing customer data input, account information, and executing commands related to engaging one or more of the service providers or vendors based on the ranking data; automatically generating a moving inventory list; and automatically generating a moving plan wherein, based on the moving plan, the computerized device notifies the customer of specific activities on specific days and provides tools to complete those activities.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a flowchart of the process for obtaining moving quotes, in accordance with an exemplary embodiment of the present invention;

FIG. 2 is a flowchart of the process for setting appointments with movers, in accordance with an exemplary embodiment of the present invention;

FIG. 3 is flowchart depicting an exemplary embodiment of the organizer platform of the present invention;

FIG. 4 is a flowchart of the mover selection and shortlisting process, in accordance with an exemplary embodiment of the present invention;

FIG. 5 is a flowchart of the move organizer vendor integration process, in accordance with an exemplary embodiment of the present invention;

FIG. 6 provides an exemplary timeline prior to and after a move or relocation has been executed;

FIG. 7 provides a diagram depicting the manner by which the present invention matches consumers with moving companies; and

FIG. 8 provides a diagram depicting the manner by which the present invention facilitates the planning, organization, and execution of moving-related tasks.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides a comprehensive and automated moving concierge platform. This platform (referred to herein as “MoveEasy”) assists consumers with the entire moving process, starting typically from 45-60 days before a move date to 30-45 days after the move date with the help of automated reminders and numerous resources. The platform first helps consumers find reputable moving companies without having to share their contact information with any particular mover. Consumers provide basic move details such as their origin and destination, move date, and predicted size of the move. Depending on the size of the move, consumers are asked to either provide details of their inventory with regard to smaller sized moves (2 bedrooms or less), or their availability for an in-house survey with regard to larger sized moves (3 bedrooms or more). For smaller moves, the platform also eases the inventory completion process by presenting consumers with a typical inventory list based on the size of their move. This typical inventory list has been compiled by comparing hundreds of moves of similar sizes. Consumers have the option of selecting additional inventory items through the platform if they did not find the items they were looking for in the typical inventory list. The platform also helps them calculate the number of boxes that will be needed for a specific house size.

In addition, consumers will be able see a customized list of movers that are automatically shortlisted for the specific move conditions listed by the user. Movers on the MoveEasy platform also undergo screening prior to being listed on the platform and are, for example, (i) required to be licensed and insured; (ii) required to have to have been in business for over five years; (iii) required to have A− or higher BBB rating; and (iv) required to have a physical office presence in the area that they claim to service. The platform also consolidates Better Business Bureau (BBB) ratings for moving companies; reviews posted by other consumers on MoveEasy; as well as review sites such as Google, Yelp and CitySearch; license and insurance information for moving companies; areas of service, and other relevant information all on the same platform so that the consumer does not have to visit multiple websites to research a moving company. In addition, the platform queries the consumer for additional information regarding their location and any additional services such as packing, assembly/disassembly etc., they desire. Based on this information, consumers can request quotes from the movers that they choose. For bigger homes (3BDR or higher), consumers will be able to set up appointments directly with the moving company through the MoveEasy platform. Most importantly, consumers will have complete control in choosing with which movers they wish to work.

While MoveEasy validates every single user's contact information through a combination of e-mail and phone validation, consumer contact information is not shared with the movers until the consumer books a mover or sets up an appointment with a mover. As a result, consumers will receive competitive binding quotes from multiple movers without once having to speak with any mover (other than when setting up in-home surveys, where the binding quotes will be provided in person). Since the quotes are typically binding and all inclusive, consumers do not have to worry about hidden prices or any move day surprises, thereby helping the consumer make an informed decision in choosing the most appropriate mover for their needs. The MoveEasy platform also helps consumers decide whether moving companies are the best option for them or whether they should go with rental trucks, PODS or freight trucks depending on the size of the move, distance between the move and other requirements desired by the consumer. Once it has helped consumers decide on the moving company (or a rental truck or PODS), the MoveEasy platform then helps organize their move by creating a standard move plan and setting up timely reminders throughout the move period. Since consumers typically look for movers 45-60 days before their move, the platform helps organize all move related activities 45-60 days before the actual move and 30-45 days after the move.

Consumers will also have the option of creating a personalized move plan by answering some additional questions regarding their residence and family, including details about children, pets and residence type. Once created, the move plan will notify consumers of specific activities on specific days and provide tools to complete those activities. For example, 15 days prior to their move, the platform will notify the user to change their mailing address and will provide a tool to change their address. Similarly, it will notify the user in time to set up their utilities and provide the tool to do so, in order to activate their utility services on time for their move. In order to provide the tools to complete different activities, the MoveEasy platform will integrate with hundreds of vendors and service providers so that consumers can complete all their move related activities from the MoveEasy platform in a completely automated manner. The platform will use the same screening criteria as used for the moving companies and will also integrate reviews from Google, Yelp and Citysearch, as well as BBB ratings, to help the consumer with their research. In addition, consumer information will be kept private throughout the process and will be shared with only those vendors that the consumer chooses. MoveEasy also provides a database of all gas, electric, water and trash providers across the country and will provide consumers a database of all DMV offices across the country, the procedures and documents required for change of address, getting a new license, vehicle registration, etc. The planner also helps consumers update their address with bank accounts, alumni associations, magazine subscriptions, loyalty programs, etc.

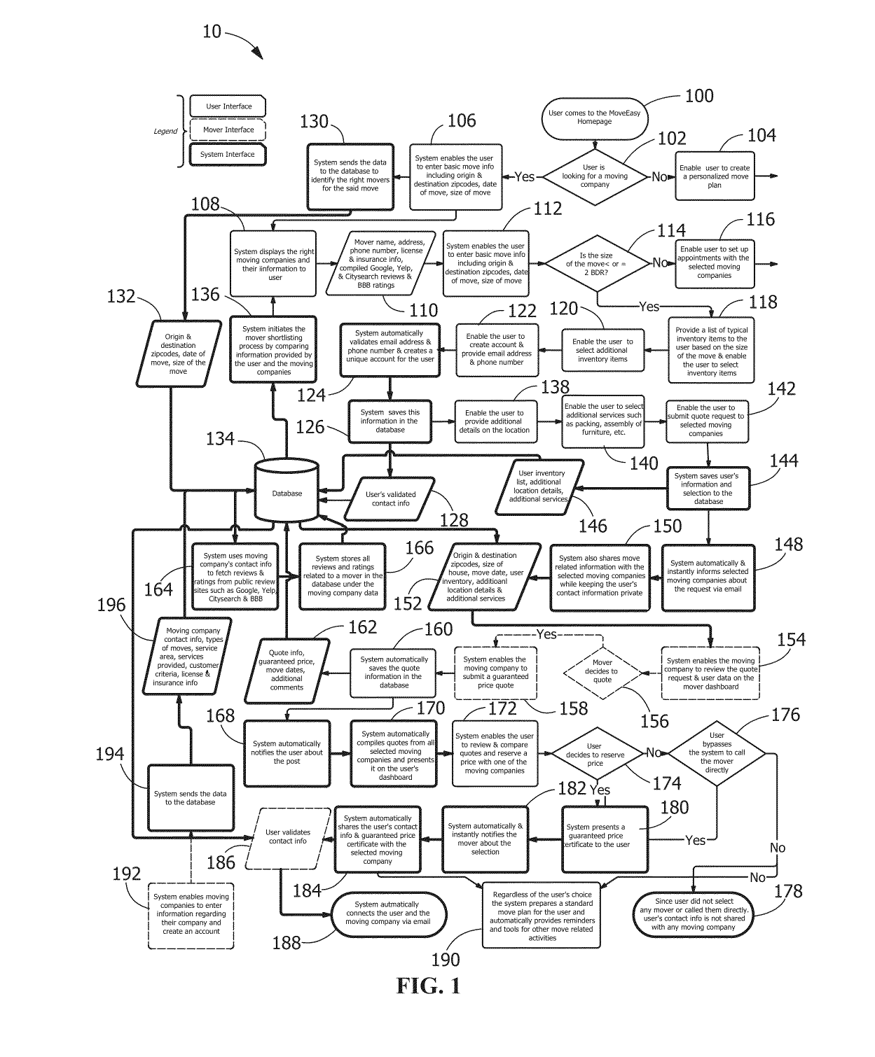

The move planner also ensures that consumers are on track with all their activities so that they do not forget anything related to their move thus resulting in a relatively hassle-free and stress-free moving or relocation experience. In some embodiments, the plan automatically ends 45 days after the consumer's move but will continue offering targeted resources to consumers from time to time based on the information they provided on the MoveEasy platform. The invention is expected to benefit all moving consumers whether they are moving by themselves, with the help of a rental truck or PODS or with the help of a professional moving company. The platform can be white labeled for businesses and integrated into their website in the form of an i-frame, widget or a branded site. FIGS. 1-8 provide much greater detail with regard to system operability and functionality.

FIG. 1 provides a flowchart of an exemplary embodiment of the present invention, a method/process 10 for obtaining moving quotes. At step 100, a user interfaces with the MoveEasy homepage. At step 102, a determination is made whether the user is looking for a moving company. If the user is not looking for a moving company, at step 104, the user is enabled to create a personalized move plan. If the user is looking for a moving company, then, at step 106, the system enables the user to enter basic move information, including origin and destination, zip codes, date of move, and the size of the move. At step 130, the system receives the data entered by the user. At step 132, the basic move information is entered into database 134. At step 192, the system enables moving companies to enter information regarding their company and to establish accounts for the moving companies. At step 194, the system receives the data from the moving companies, and at step 106, organizes the moving company information in contact information, types of moves, service area, services provided, customer criteria, and license and insurance information, which is entered into the database 134. At step 164, the system cross-references moving company information with reviews and ratings from public sites such as GOOGLE, YELP, CITYSEARCH and BBB, and at step 166, the system stores all reviews and ratings related to a moving company in the database 134 associated with the moving company data. At step 136, the system displays the correct moving companies and their information to the user. At step 110, the mover name, address, phone number, license and insurance information, and compiled review are presented to the user. At step 112, the system enables the user to compare and select a moving company. At step 114, the system receives information from the user as to whether the size of the move is less than or equal to a two-bedroom space. If the size of the move is larger than a two-bedroom space, at step 116, the system enables the user to set up appointments with a selected moving company. If however, the size of the move is less than or equal to a two-bedroom space, then at step 118, the system provides the user with a list of typical inventory items based on the size of the move and enables the user to select inventory items. At step 120, the system enables the user to select additional inventory items. At step 122, the system enables the user to create an account and provide an e-mail address and telephone number. The system automatically validates the user-provided e-mail address and telephone number, and assigns a unique account for the user at step 124. At step 126, the system saves the user-provided information in database 134, and at step 128 denotes that the user contact information is validated. At step 138, the system enables the user to provide additional details on the location, and at step 140 enables the user to select additional services such as packing, assembly of furniture and related items. The system enables the user to submit quote requests to the selected moving companies at step 142, and saves user-provided information at step 144. At step 146, the user-provided information is organized into a user inventory list, additional location details, and additional services, and is saved to database 134. At step 148, the system automatically and instantly informs selected moving companies about the request by way of email, and at step 150 shares move related information automatically with the selected moving companies while keeping the user's contact information private. At step 152, the combined origin and destination zip codes, the size of the space to be moved, the move date, the user inventory, the additional location details and additional services are organized into the communication to the moving company or companies, and at step 154, the system enables the moving company to review the quote and request user data on the mover dashboard. At step 156, the moving company is provided an option to provide a quote. If the mover elects to provide a quote, then at step 158, the system enables the moving company to submit a guaranteed price quote. The system automatically saves the moving company quote at step 160, organized into quote information, guaranteed price, move dates and additional comments at step 162, into the database 134. The system notifies the user about the moving company quote at step 168, and provides an automatically compiled quote from all selected moving companies and presents it on the user's dashboard at step 170. At step 172, the system enables the user to review and compare quotes, and to reserve a price with one of the moving companies. At step 174, the user is provided an option to reserve the price. If the user elects not to reserve a price, the user may elect to bypass the system to call a moving company directly at step 176. If the user does not call a moving company directly, then at step 178, the user's contact information is not shared with any moving company. If the user does call a moving company directly, or if the user decides to reserve the price at step 174, then, at step 180, the system presents a guaranteed price certificate to the user, at step 182, automatically and instantly notifies the moving company about the user's election, and at step 184, automatically shares the user's contact information and guaranteed price certificate with the selected moving company. At step 186, the user validated contact information is accessed from the database 134, and at step 188, the system automatically connects the user and the moving company by way of e-mails. Regardless of the user's election at steps 174 and 176, the system prepares a standard move plan for the user and automatically provides reminders and tools for other move related activities at step 190.

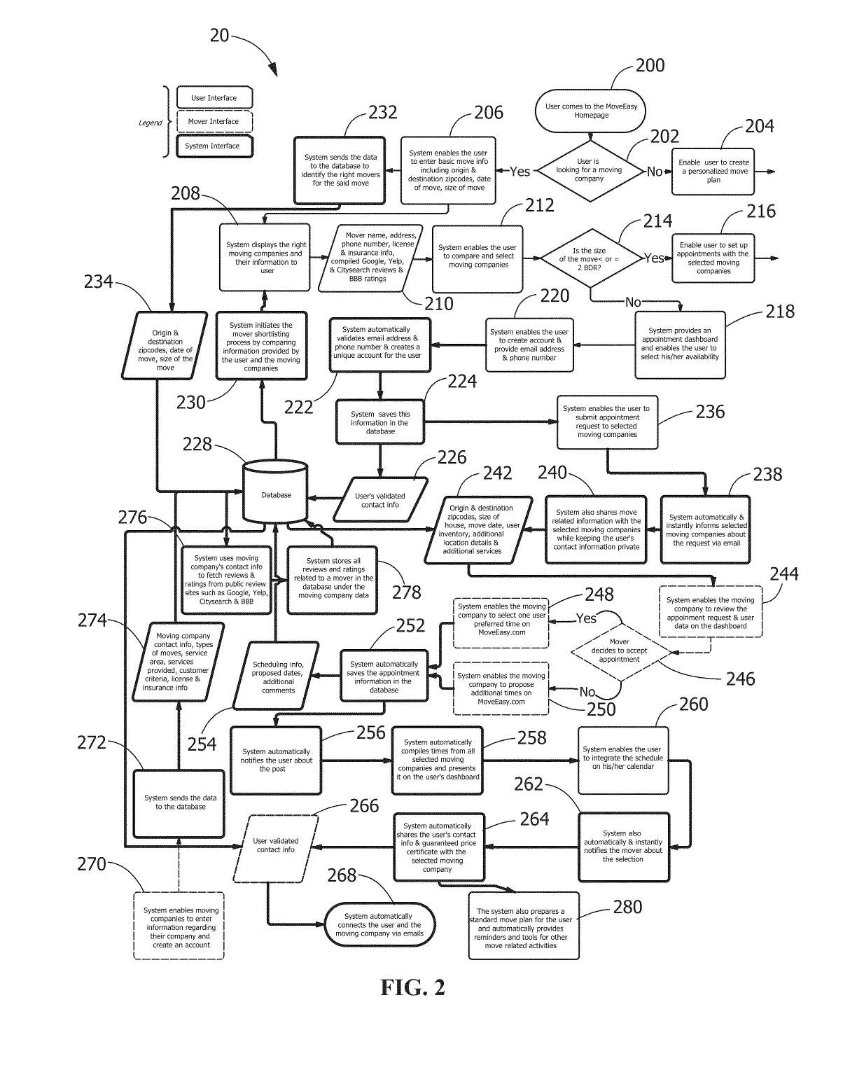

FIG. 2 provides a flowchart of an exemplary embodiment of the present invention, a method/process 20 for setting appointments with movers. At step 200, a user interfaces with the MoveEasy homepage. At step 202, a determination is made whether the user is looking for a moving company. If the user is not looking for a moving company, then at step 204, the user is enabled to create a personalized move plan. If the user is looking for a moving company, then at step 206, the system enables the user to enter basic move information including origin and destination zip codes, the date of the move and the size of the move. At step 232, the system receives the data entered by the user, and, at step 234, the basic move information is entered into database 228. At step 270, the system enables moving companies to enter information regarding their company and to establish accounts for the moving companies. At step 272, the system receives the data from the moving companies, and at step 274, organizes the moving company information in contact information, types of moves, service area, services provided, customer criteria, and license and insurance information, which is entered into the database 228. At step 276, the system cross-references moving company information with reviews and ratings from public sites such as GOOGLE, YELP, CITYSEARCH and BBB, and at step 278, the system stores all reviews and ratings related to a moving company in the database 228, associated with the moving company data. At step 230, the system initiates the moving company shortlisting process by comparing information provided by the user and the moving company, and at step 208 the system displays the right moving companies and their information to the user. At step 210, the information provided to the user includes the moving company name, address, telephone number, license and insurance information, and the compiled reviews. At step 212, the system enables the user to compare and select moving companies. At step 214, the system receives information from the user as to whether the size of the move is less than or equal to a two-bedroom space. If the size of the move is larger than a two-bedroom space, at step 216, the system enables the user to set up appointments with a selected moving company. If, however, the size of the move is less than or equal to a two-bedroom space, then at step 218, the system enables the user to create an account and provide an email address and telephone number. The system automatically validates the user-provided email address and telephone number, and assigns a unique account for the user at step 222. At step 224, the system saves the user-provided information in database 228, and at step 226 denotes that the user contact information is validated. At step 236, the system enables the user to submit appointment requests to selected moving companies, and automatically and instantly informs the selected moving companies about the request via email at step 238. At step 240, the system shares move related information automatically with the selected moving companies while keeping the user's contact information private. At step 242, the combined origin and destination zip codes, the size of the space to be moved, the move date, and the available appointment times are organized into the communication to the moving company or companies, and at step 244, the system enables the moving company to review the appointment request and user data on the mover dashboard. At step 246, the moving company is provided an opportunity to accept the user-proposed appointment. At step 248, if the moving company accepts the appointment, the system enables the moving company to select one user preferred time. At step 250, if the moving company does not accept the appointment, the system enables the moving company to propose additional times. Regardless of the moving company's decision at step 246, at step 252, the system automatically saves the appointment information in the database 228. At step 254, the saved appointment information includes the scheduling information, proposed dates and additional comments. At step 256, the system automatically notifies the user about the posted appointment, and at step 258, the system automatically compiles the appointment times from all selected moving companies and presents it on the user's dashboard. At step 260, the system enables the user to integrate the schedule on the user's calendar, and automatically and instantly notifies the moving company about the selection at step 262. At step 264, the system automatically shares the user's contact information and guaranteed price certificate with the selected moving company, retrieving user validated contact information from the database 228 at step 266, and automatically connects the user and the moving company at step 268. At step 280, the system also prepares a standard move plan for the user and automatically provides reminders and tools for other move related activities.

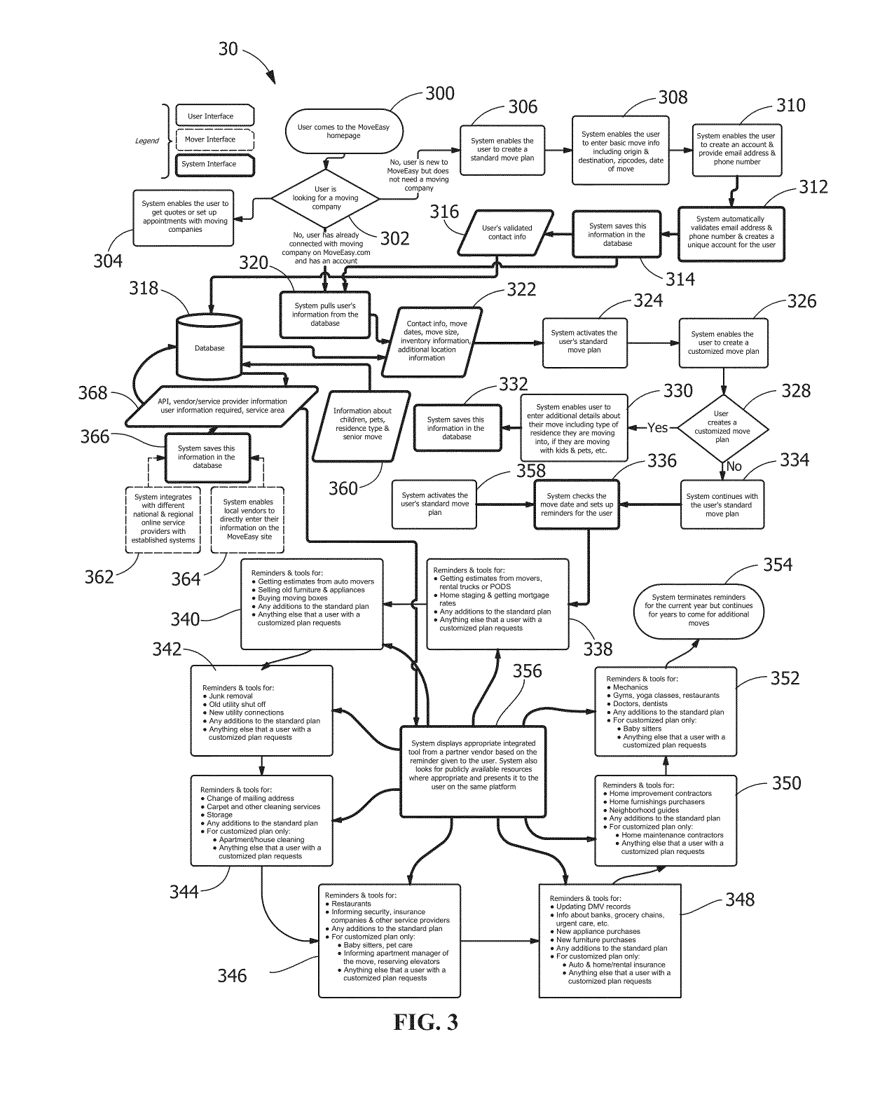

FIG. 3 provides a flowchart of an exemplary embodiment of the present invention, a method/process 30 for an organizer platform. At step 300, a user interfaces with the MoveEasy homepage. At step 302, a determination is made whether the user is looking for a moving company. If the user is looking for a moving company, then at step 304, the user is enabled to get quotes or set up appointments with moving companies. If the user is not looking for a moving company, and is new to MoveEasy, then, at step 306, the system enables the user to create a standard move plan. At step 308, the system enables the user to enter basic move information including origin and destination zip codes, and the date of the move, and at step 310, the system enables the user to create an account and provide contact information such as an email address and telephone number. At step 312, the system automatically validates the provided contact information and creates a unique account for the user. At step 314, the system saves the user's validated contact information, and at step 316, transfers the information to database 318. At step 360, information regarding children pets, residence type and senior move is entered into the database 318. At step 362, the system integrates with different national and regional online service providers with established systems, and at step 364, the system enables local vendors to directly enter their information on the MoveEasy site, which information is saved by the system in the database 318 at step 366, categorized as API, vendor/service provider information, user information required and service area at step 368. If the user is not looking for a moving company at step 302, but already has an account with MoveEasy, or following step 314, at step 320, the system accesses the user's information from the database 318, and at step 322 pulls the contact information, move dates, move size, inventory information and any additional information stored in the database 318. At step 324, the system activates the user's standard move plan, and at step 326, the system enables the user to create a customized move plan. If at step 328 the system receives a customized move plan from the user, then, at step 330, the system enables the user to enter additional details about the user's move, including type of residence being moved into, and if children or pets will be involved, and, at step 332, the system saves this information in the database 318. If, however, at step 328, the system does not receive a customized move plan from the user, then, at step 334, the system continues with the user's standard move plan. At step 358, the system activates the user's standard move plan, and at step 336, the system checks the move date and sets up reminders for the user. At step 356, the system displays appropriate integrated tools from a partner vendor based on the reminder to be given to the user, and also looks for publically available resources where appropriate and presents it to the user on the same platform. At step 338, the reminders and tools provided by the system include getting estimates from movers, rental trucks or PODS, home staging and getting mortgage rates, any additions to the standard plan, and anything else that a user with a customized plan requests. At step 340, the reminders and tools provided by the system include getting estimates from auto movers, selling old furniture and appliances, buying moving boxes, any additions to the standard plan, and anything else that a user with a customized plan requests. At step 342, the reminders and tools provided by the system include junk removal, old utility shut off, new utility connection, any additions to the standard plan, and anything else that a user with a customized plan requests. At step 344, the reminders and tools provided by the system include change of mailing address, carpet and other cleaning services, storage, any additions to the standard plan, and for customized plans only, apartment or house cleaning and anything else that a user with a customized plan requests. At step 346, the reminders and tools provided by the system include restaurants, informing security, insurance companies and other service providers, any additions to the standard plan, and, for customized plans only, baby sitters, pet care, informing apartment manager of the move, reserving elevators, and anything else that a user with a customized plan requests. At step 348, the reminders and tools provided by the system include updating DMV records, information about banks, grocery chains, and urgent care, new appliance purchase, new furniture purchase, any additions to the standard plan, and, for customized plans only, auto and home/rental insurance and anything else that a user with a customized plan requests. At step 350, the reminders and tools provided by the system include home improvement contractors, home furnishing purchases, neighborhood guides, any additions to the standard plan, and, for customized plans only, home maintenance contractors and anything else that a user with a customized plan requests. At step 352, the reminders and tools provided by the system include mechanics, gyms, yoga classes, restaurants, doctors, dentists, any additions to the standard plan, and, for customized plans only, baby sitters and anything else that a user with a customized plan requests. At step 354, the system terminates reminders for the current year, but continues for years to come for additional moves.

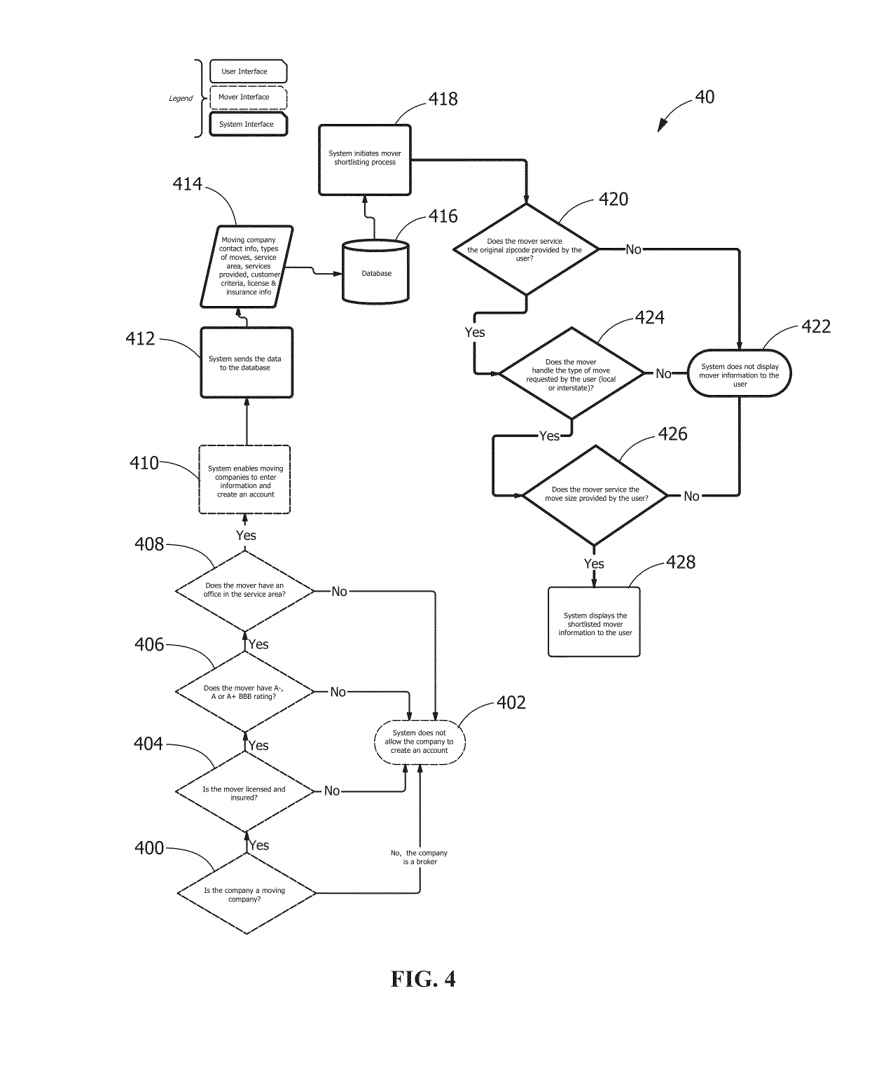

FIG. 4 provides a flowchart of an exemplary embodiment of the present invention, a method/process 40 for mover selection and shortlisting. At step 400, a determination is made as to whether a company is a moving company. If not, at step 402, the system does not allow the company to create an account. If the company is a moving company, then at step 404, a determination is made as to whether the moving company is licensed and insured. If not, at step 402, the system does not allow the company to create an account. If the moving company is licensed and insured, then, at step 406, a determination is made as to whether the moving company has an A−, A or A+ BETTER BUSINESS BUREAU rating. If not, at step 402, the system does not allow the company to create an account. If the moving company is sufficiently rated, then, at step 408, a determination is made as to whether the moving company has an office in the service area. If not, at step 402, the system does not allow the company to create an account. If the moving company does have an office in the service area, then the system enables the moving company to enter information and create an account at step 410. At step 412, the system gathers data, organized at step 414 into moving company contact information, types of moves, service area, services provided, customer criteria, and license and insurance information, which is entered into database 416. At step 418, the system initiates the mover shortlisting process. At step 420, a determination is made as to whether the moving company services the origin zip code provided by the user. If no, then, at step 422, the system does not display the mover information to the user. If yes, then, at step 424, a determination is made as to whether the moving company handles the type of move requested by the user, such as local or interstate. If no, then at step 422, the system does not display the mover information to the user. If yes, then, at step 426, a determination is made as to whether the moving company services the move size provided by the user. If no, then at step 422, the system does not display the mover information to the user. If yes, then, at step 428, the system displays the shortlisted moving company information to the user.

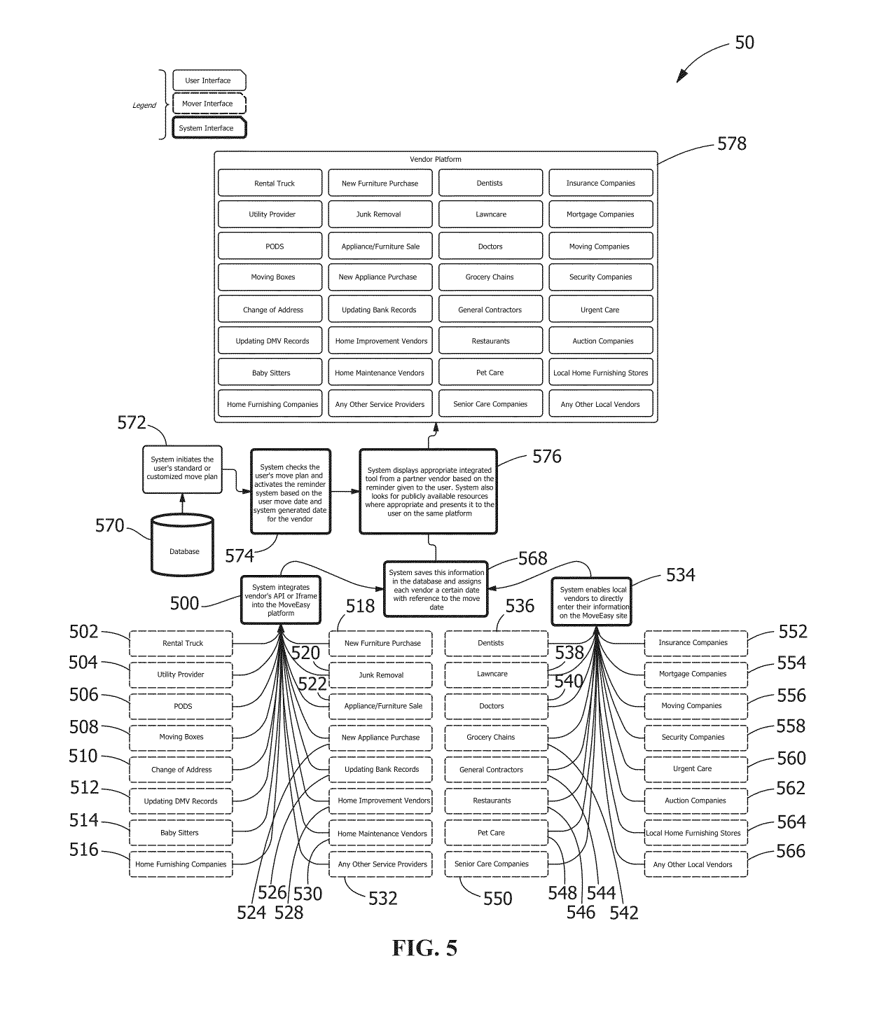

FIG. 5 provides a flowchart of an exemplary embodiment of the present invention, a method/process 50 for integrating a move organizer At step 500, the system integrates vendor API or Iframe into the MoveEasy platform, including, by way of example, rental truck 502, utility provider 504, PDS 506, moving boxes 508, change of address 510, updating DMV records 512, baby sitters 514, home furnishing companies 516, new furniture purchase 518, junk removal 520, appliance furniture sale 522, new appliance purchase 524, updating bank records 526, home improvement vendors 528, home maintenance vendors 530, and any other service providers 532. At step 534, the system enables local vendors to directly enter their information on the MoveEasy site, including, by way of example, dentists 536, lawn care 538, doctors 540, grocery chains 542, general contractors 544, restaurants 546, pet care 548, senior care companies 550, insurance companies 552, mortgage companies 554, moving companies 556, security companies 558, urgent care 560, auction companies 562, local home furnishing store 564, and any other local vendors 566. At step 568, the system saves the information from steps 500 and 534 in database 570, and assigns each vendor a certain date with reference to the move date. At step 572, the system initiates the user's standard or customized move plan, and at step 574, checks the user's move plan and activates the reminder system based on the user move date and system generated date for the vendor. At step 576, the system displays appropriate integrated tools from partner vendors based on the reminders to the user. The system also looks for publically available resources where appropriate and presents it to the user on the same platform 578.

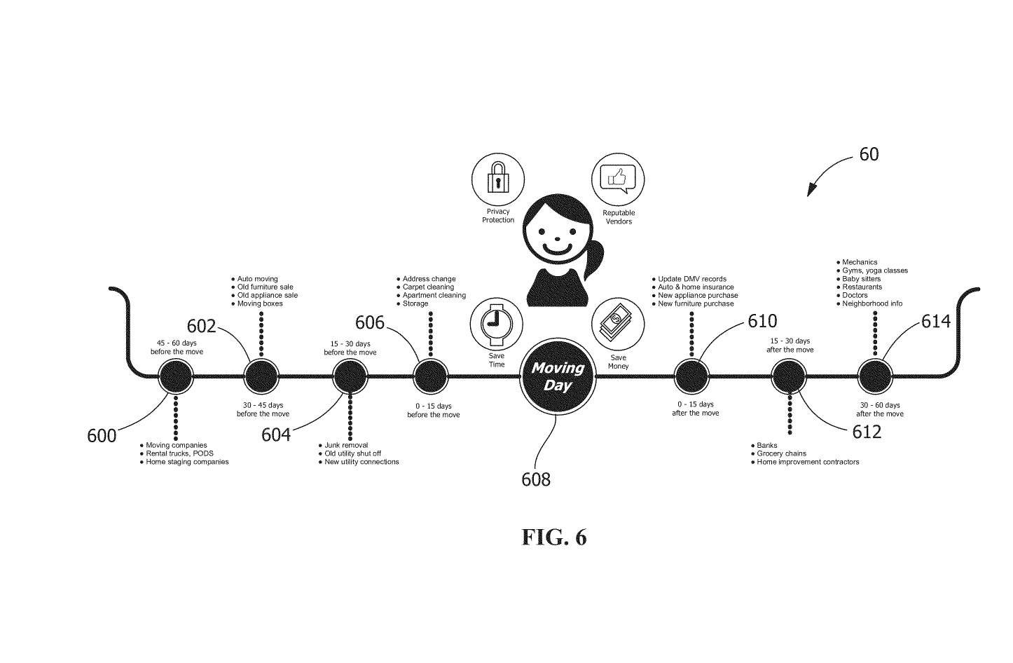

FIG. 6 provides a flowchart of an exemplary embodiment of the present invention, a method/process 60 for the timeline prior to and after a move or relocation has been executed. At step 600, 45-60 days before the move, moving companies, rental trucks, PODS, and home staging companies are prompted. At step 602, 30-45 days before the move, auto moving, old furniture sale, old appliance sale and moving boxes are prompted. At step 604, 15-30 days before the move, junk removal, old utility shutoff and new utility connections are prompted. At step 606, 0-15 days before the move, address change, carpet cleaning, apartment cleaning and storage are prompted. Step 608 represents the day of moving. At step 310, 0-15 after the move, updating DMV records, auto and home insurance, new appliance purchases and new furniture purchases are prompted. At step 612, 15-30 days after the move, banks, grocery chains and home improvement contractors are prompted. At step 614, 30-60 days after the move, mechanics, gyms, yoga classes, baby sitters, restaurants, doctors and neighborhood information is prompted.

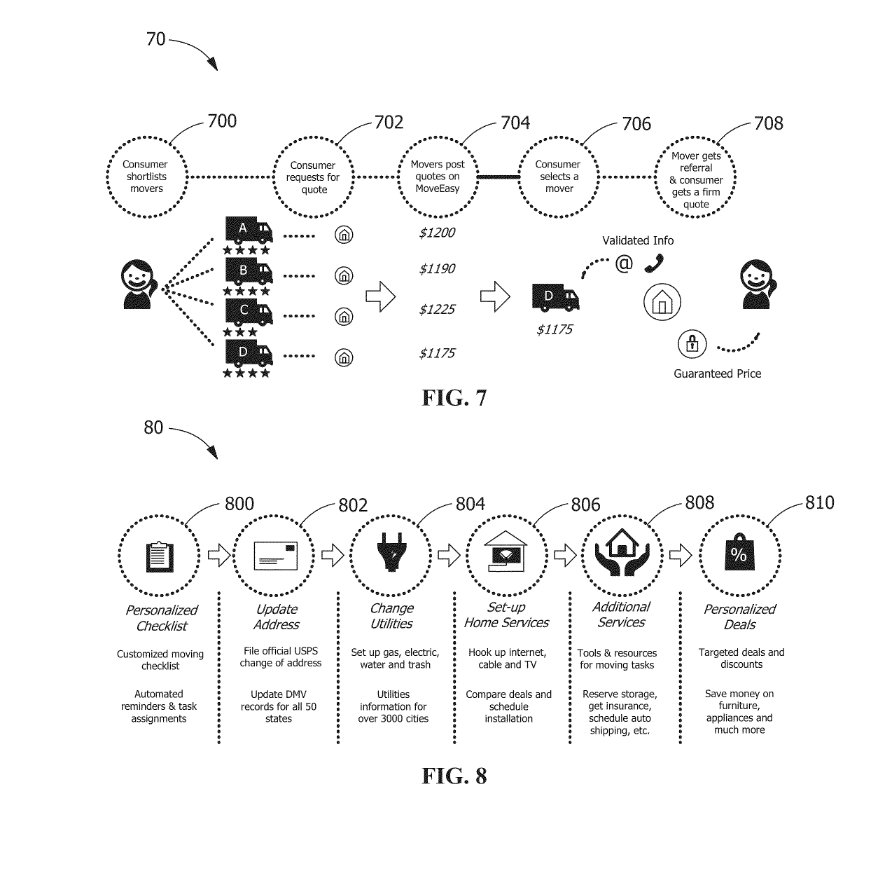

FIG. 7 provides a flowchart of an exemplary embodiment of the present invention, a method/process 70 for matching consumers with moving companies. At step 700, the consumer shortlists movers. At step 702, the consumer requests for quotes. At step 704, the movers post quotes on MoveEasy. At step 706, the consumer selects a mover. At step 708, the mover gets the referral and the consumer gets a firm quote.

FIG. 8 provides a flowchart of an exemplary embodiment of the present invention, a method/process 80 for planning, organizing and executing move-related tasks. At step 800, the system provides a personalized/customized moving checklist, and automated reminders and task assignments commence. At step 802, the system updates addresses, including filing an official USPS change of address and updating DMV records for all fifty states. At step 804, the system changes utilities, including setting up gas, electric, water and trash, and providing utility information for over 3,000 cities. At step 806, the system sets up home services, including hooking up internet, cable and television, and comparing deals and scheduling installation. At step 808, the system performs additional services, including tools and resources for moving tasks, reserving storage, getting insurance, scheduling auto shipping and other tasks. At step 810, the system provides personalized deals, including targeted deals and discounts, saving money on furniture, appliances, and other expenses.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the Applicant's general inventive concept.

What is claimed:

1. An automated system for facilitating moving logistics, comprising:
(a) a plurality of service providers and vendors, wherein the service providers and vendors are associated with moving or relocation activities;
(b) automated means for compiling information about each of the service providers and vendors and ranking them in accordance with various predetermined criteria;
(c) at least one computerized database for containing information about the service providers and vendors and for storing the ranking data; and
(d) at least one computerized device in communication with the at least one database, wherein the at least one computerized device further includes software for managing customer data input, account information, and executing commands related to engaging one or more of the service providers or vendors based on the ranking data.

2. The system of claim 1, wherein the computerized device is a smartphone.

3. The system of claim 1, wherein the computerized device is a personal computer.

4. The system of claim 1, wherein the software is application software.

5. The system of claim 1, wherein the system automatically generates a moving inventory list.

6. The system of claim 1, wherein the system automatically generates a moving plan, and wherein based on the moving plan, the computerized device notifies the customer of specific activities on specific days and provides tools to complete those activities.

7. The system of claim 1, wherein the system generates a moving plan based on direct customer input.

8. The system of claim 1, wherein services provided by the system automatically terminate after a predetermined period of time.

9. An automated method for facilitating moving logistics, comprising:
(a) providing a plurality of service providers and vendors, wherein the service providers and vendors are associated with moving or relocation activities;
(b) providing automated means for compiling information about each of the service providers and vendors and ranking them in accordance with various predetermined criteria;
(c) providing at least one computerized database for containing information about the service providers and vendors and for storing the ranking data; and
(d) providing at least one computerized device in communication with the at least one database, wherein the at least one computerized device further includes software for managing customer data input, account information, and executing commands related to engaging one or more of the service providers or vendors based on the ranking data.

10. The method of claim 9, wherein the computerized device is a smartphone.

11. The method of claim 9, wherein the computerized device is a personal computer.

12. The system of claim 9, wherein the software is application software.

13. The method of claim 9, further comprising automatically generating a moving inventory list.

14. The method of claim 9, further comprising automatically generating a moving plan, and wherein based on the moving plan, the computerized device notifies the customer of specific activities on specific days and provides tools to complete those activities.

15. The method of claim 9, further comprising generating a moving plan based on direct customer input.

16. The method of claim 9, wherein services provided to the customer automatically terminate after a predetermined period of time.

17. An automated method for facilitating moving logistics, comprising:
(a) providing a plurality of service providers and vendors, wherein the service providers and vendors are associated with moving or relocation activities;
(b) providing automated means for compiling information about each of the service providers and vendors and ranking them in accordance with various predetermined criteria;
(c) providing at least one computerized database for containing information about the service providers and vendors and for storing the ranking data;
(d) providing at least one computerized device in communication with the at least one database, wherein the at least one computerized device further includes software for managing customer data input, account information, and executing commands related to engaging one or more of the service providers or vendors based on the ranking data.
(d) automatically generating a moving inventory list; and
(e) automatically generating a moving plan, wherein based on the moving plan, the computerized device notifies the customer of specific activities on specific days and provides tools to complete those activities.

18. The method of claim 17, wherein the computerized device is a smartphone.

19. The method of claim 17, wherein the computerized device is a personal computer.

20. The method of claim 17, wherein services provided to the customer automatically terminate after a predetermined period of time.
